(19) United States
(12) Patent Application Publication
(10) Pub. No.: US 2025/0244636 A1
(43) Pub. Date: Jul. 31, 2025

(54) OPTICAL FREQUENCY COMB-BASED TERAHERTZ FREQUENCY GENERATOR, AND OPERATING METHOD THEREOF

(71) Applicant: KOREA ADVANCED INSTITUTE OF SCIENCE AND TECHNOLOGY, Daejeon (KR)

(72) Inventors: Young-Jin KIM, Daejeon (KR); Seung-Woo KIM, Daejeon (KR); Dongchel SHIN, Daejeon (KR); Guseon KANG, Daejeon (KR); Byung Soo KIM, Daejeon (KR); Jaeyoon KIM, Daejeon (KR)

(21) Appl. No.: 18/978,184

(22) Filed: Dec. 12, 2024

(30) Foreign Application Priority Data
Jan. 31, 2024 (KR) 10-2024-0015150
Sep. 19, 2024 (KR) 10-2024-0126509

(51) Int. Cl. G02F 1/35

(52) U.S. Cl. CPC G02F 1/3534; G02F 1/3503; G02F 2203/13

(57) ABSTRACT

A terahertz frequency generator includes: a source laser configured to output an optical frequency comb; a first stabilization module configured to stabilize the optical frequency comb to a frequency reference source; a heterodyne module configured to extract a pair of comb lines from the stabilized optical frequency comb, with a frequency difference corresponding to a terahertz frequency, and optically couple the pair of comb lines; and a photomixer configured to convert an optical signal generated by the heterodyne module into the terahertz frequency.

### CROSS-REFERENCE TO RELATED APPLICATION

This application claims priority to and the benefit of Korean Patent Application No. 10-2024-0015150 filed in the Korean Intellectual Property Office on Jan. 31, 2024 and Korean Patent Application No. 10-2024-0126509 filed in the Korean Intellectual Property Office on Sep. 19, 2024, the entire contents of which are incorporated herein by reference.

### BACKGROUND

### (a) Field

The present invention relates to optical frequency comb-based signal generation.

### (b) Description of the Related Art

Terahertz wave sources are essential in various application fields including molecular spectroscopy, terahertz radar, and wireless communication, with increasing demand for frequency stability and accuracy. In particular, next-generation wireless communication requires high-precision signal sources to authenticate terahertz devices. Additionally, precise terahertz signal sources are necessary to enable high-density data transmission through high-dimensional signal modulation such as 32-Quadrational Amplitude Modulation (QAM). For terahertz radar, a low-noise terahertz signal source is required to enhance signal-to-noise sensitivity while being less vulnerable to weather and surrounding light compared to light detection and ranging (LIDAR).

The development of terahertz signal sources has advanced with the emergence of optical frequency combs, but further research is needed to improve phase noise and frequency stability to fully support terahertz application.

### SUMMARY

The present disclosure attempts to provide an optical frequency comb-based terahertz frequency generator and a method thereof.

Some exemplary embodiments provide a terahertz frequency generator which includes: a source laser configured to output an optical frequency comb; a first stabilization module configured to stabilize the optical frequency comb to a frequency reference source; a heterodyne module configured to extract a pair of comb lines from the stabilized optical frequency comb, with a frequency difference corresponding to a terahertz frequency, and optically couple the pair of comb lines; and a photomixer configured to convert an optical signal generated by the heterodyne module into the terahertz frequency.

The frequency reference source may include an optical cavity made of ultra-low expansion glass.

The first stabilization module may include: a comb line extraction unit configured to extract a specific comb line from the optical frequency comb; a control unit configured to generate a control frequency for locking the specific comb line to a resonance peak of the optical cavity; and an acousto-optic modulator configured to shift the optical frequency comb according to the control frequency.

The terahertz frequency generator may further include a second stabilization module configured to stabilize the optical frequency comb through self-referencing. The second stabilization module may include: an interferometer configured to detect a carrier envelope offset in an output of the source laser; a feedback circuit configured to generate a feedback signal to counterbalance the control frequency by the carrier envelope offset; and a pump laser diode configured to adjust the carrier envelope offset output by the source laser based on the feedback signal.

The heterodyne module may include: a pair of comb line extraction units configured to extract the pair of comb lines from the stabilized optical frequency comb; and a thermal noise compensation circuit configured to actively compensate for thermal noise in an optical fiber transmission line by modulating each comb line output from each of the pair of comb line extraction units based on the optical signal detected at an inlet of the photomixer.

The thermal noise compensation circuit may include: a pair of acousto-optic modulators configured to modulate the comb lines extracted by the pair of comb line extraction units; and a circuit configured to feedback a difference between each comb line modulated by each of the pair of acousto-optic modulators and the optical frequency comb to the corresponding acousto-optic modulator.

Each of the pair of comb line extraction units may include: an optical filter configured to filter out a designated comb line from the optical frequency comb; and a laser diode configured to extract a comb line of a frequency mode designated through injection locking for the comb line filtered out by the optical filter.

The laser diode of at least one of the pair of comb line extraction units may be configured to successively shift in an operating window of the injection locking to scan the extracted comb line.

Some exemplary embodiments provide a terahertz frequency generator which includes: a source laser configured to output an optical frequency comb; a first stabilization module configured to stabilize the optical frequency comb to a frequency reference source; a second stabilization module configured to stabilize the optical frequency comb through self-referencing; and a heterodyne module configured to extract a pair of comb lines from the stabilized optical frequency comb, with a frequency difference corresponding to a terahertz frequency, compensate for thermal noise in an optical fiber transmission line of the pair of comb lines, and then optically couple the thermal noise-compensated pair of comb lines.

The frequency reference source may include an optical cavity made of ultra-low expansion glass.

The first stabilization module may include: a comb line extraction unit configured to extract a specific comb line from the optical frequency comb; a control unit configured to generate a control frequency for locking the specific comb line to a resonance peak of the optical cavity; and an acousto-optic modulator configured to shift the optical frequency comb according to the control frequency.

The second stabilization module may include: an interferometer configured to detect a carrier-envelope offset in an output of the source laser; a feedback circuit configured to generate a feedback signal to counterbalance the control frequency by the carrier-envelope offset; and a pump laser diode configured to adjust the carrier-envelope offset output by the source laser based on the feedback signal.

The heterodyne module may include: a pair of comb line extraction units configured to extract the pair of comb lines from the stabilized optical frequency comb; and a thermal noise compensation circuit configured to actively compensate for the thermal noise in the optical fiber transmission line by modulating each comb line output by each of the pair of comb line extraction units based on the optical signal detected at an end of the optical fiber transmission line.

The thermal noise compensation circuit may include: a pair of acousto-optic modulators configured to modulate the comb lines extracted by the pair of comb line extraction units; and a circuit configured to feedback a difference between each comb line modulated by each of the pair of acousto-optic modulators and the optical frequency comb to the corresponding acousto-optic modulator.

Each of the pair of comb line extraction units may include: an optical filter configured to filter out a designated comb line from the optical frequency comb; and a laser diode configured to extract a comb line of a frequency mode designated through injection locking for the comb line filtered out by the optical filter.

The laser diode of at least one of the pair of comb line extraction units may be configured to successively shift in an operating window of the injection locking to scan the extracted comb line.

The terahertz frequency generator may further include a photomixer configured to convert an optical signal generated by the heterodyne module into the terahertz frequency.

Some exemplary embodiments provide an operating method of a terahertz frequency generator, which include: generating an optical frequency comb stabilized to a frequency reference source; extracting a pair of comb lines from the stabilized optical frequency comb, with a frequency difference corresponding to a terahertz frequency; compensating for thermal noise in an optical fiber transmission line that transmits the pair of comb lines, using a thermal noise compensation circuit; generating an optical signal by optically coupling the thermal noise-compensated pair of comb lines; and converting the optical signal into the terahertz frequency using a photomixer.

The operating method may further include stabilizing the optical frequency comb through self-referencing.

The extracting the pair of comb lines may include extracting a comb line of a specific frequency mode while scanning a frequency domain by controlling injection locking of a laser diode, which extracts one comb line of the pair of comb lines.

According to the present disclosure, a terahertz frequency can be generated from a pair of comb lines extracted from a stabilized optical frequency comb.

According to the present disclosure, at least one comb line of the pair of comb lines is consecutively shifted without releasing stabilization of the optical frequency comb to generate a wide-range terahertz frequency

According to the present disclosure, a phase noise performance at a very low level can be provided, and a terahertz frequency having high stability and accuracy can be generated.

According to the present disclosure, a signal to noise ratio of a terahertz radar, a decomposition ability of terahertz molecular spectroscopy, and a transmission capacity of wireless communication can be dramatically improved.

### BRIEF DESCRIPTION OF THE DRAWINGS

FIG. 1 is a diagram for conceptually describing terahertz frequency generation according to an exemplary embodiment.

FIG. 2 is a configuration diagram of a terahertz frequency generator according to an exemplary embodiment.

FIG. 3 is a basic configuration diagram of an optical synthesis module according to an exemplary embodiment.

FIG. 4 is a configuration diagram of a terahertz frequency generator including a thermal noise compensation circuit and a terahertz phase noise measurement according to an exemplary embodiment.

FIG. 5 is a graph showing a phase noise performance according to an exemplary embodiment.

FIG. 6 is a configuration diagram for absolute measurement of a terahertz frequency according to an exemplary embodiment.

FIG. 7 is a diagram for describing continuous tuning of the terahertz frequency according to an exemplary embodiment.

FIG. 8 is a flowchart of a terahertz frequency generation method according to an exemplary embodiment.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and descriptions are to be regarded as illustrative in nature and not restrictive. Like reference numerals designate like elements throughout the specification.

In the description, unless explicitly described to the contrary, the word “comprise”, and variations such as “comprises” or “comprising”, will be understood to imply the inclusion of stated elements but not the exclusion of any other elements.

In the description, reference numerals and names are arbitrarily shown for understanding and ease of description, but the present disclosure is not limited thereto.

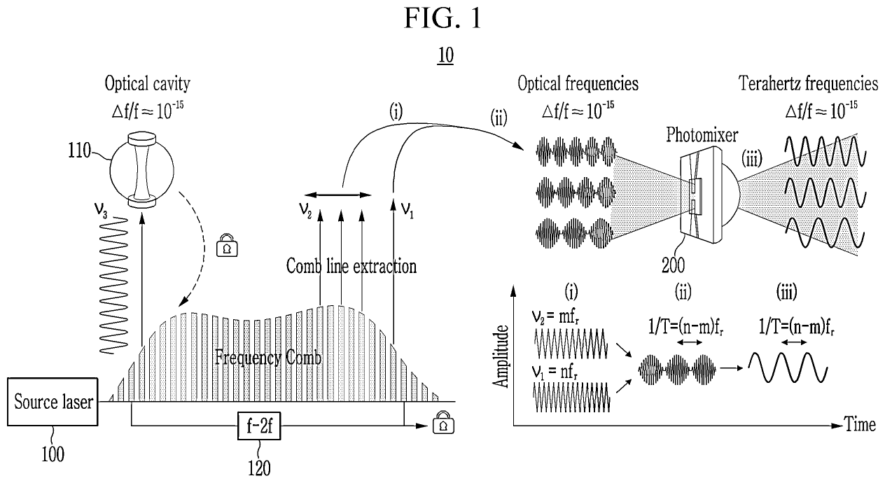

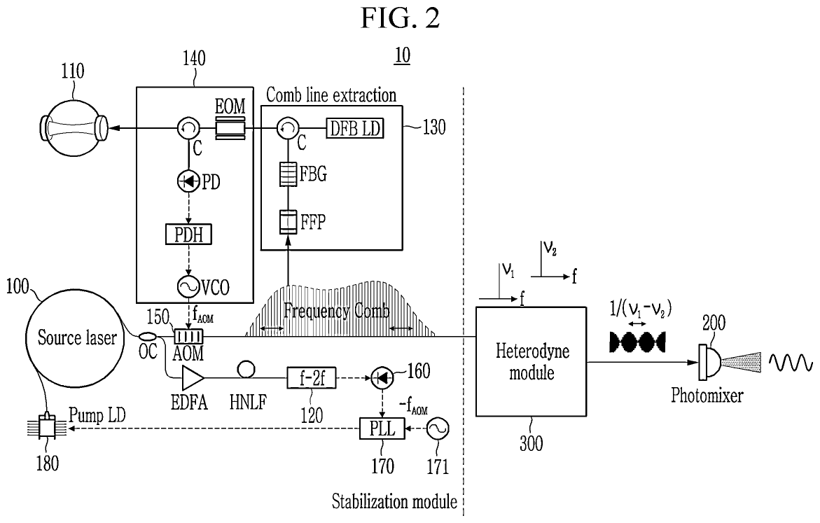

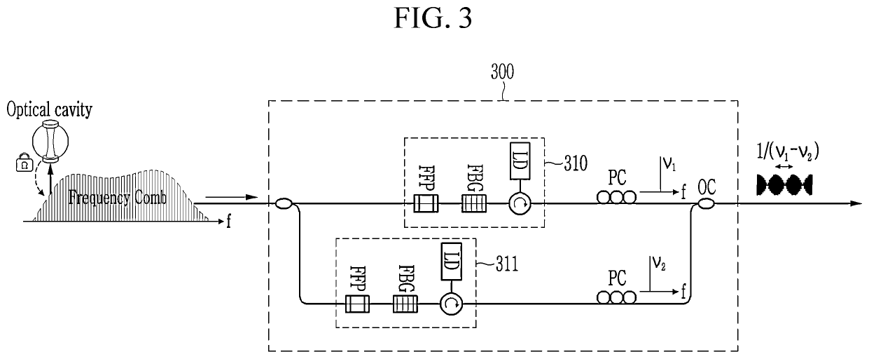

FIG. 1 is a diagram for conceptually describing terahertz frequency generation according to an exemplary embodiment, FIG. 2 is a configuration diagram of a terahertz frequency generator according to an exemplary embodiment, and FIG. 3 is a basic configuration diagram of an optical synthesis module according to an exemplary embodiment.

Referring to FIG. 1, the terahertz frequency generator 10 is configured to generate a terahertz frequency by heterodyne-mixing a pair of comb lines v₁ and v₂ extracted from an optical frequency comb. An optical difference between a pair of comb lines, |v₁−v₂| corresponds to the terahertz frequency. A photomixer 200 may emit a terahertz wave. The terahertz wave may be detected by a photoconductive antenna.

A source laser 100 may be a pulse laser which generates pulse train in a time domain, and may be a femtosecond laser which outputs femtosecond pulse train. When the pulse train is viewed in a frequency domain, discontinuous spectrums with a predetermined frequency interval (repetition rate) are observed, which are referred to as an optical frequency comb (OFC).

One comb line (or also referred to as ‘comb’) constituting the optical frequency comb may be expressed as an integer multiple of the repetition rate. An n-th comb line of the optical frequency comb may be referred to as an n-th frequency mode. For example, the n-th comb line may be expressed as an integer multiple (n=1, 2, 3, . . . ) of a carrier envelope offset fₒ and a repetition rate fᵣ as in Equation 1.

v=nfᵣ+fₒ (Equation 1)

The frequency mode of the optical frequency comb may achieve a precise value through stabilization of the repetition rate and the carrier envelope offset, enabling the generation of the low-noise terahertz frequency.

The source laser 100 may be locked and stabilized to a frequency reference source. The frequency reference source may vary, such as an atomic clock, an optical clock. In the description, an optical cavity 110 made of ultra-low expansion (ULE) glass will be described as an example. The optical frequency comb is tuned in the frequency domain using an acousto-optic modulator (AOM), resulting in one comb line v3 extracted from the optical frequency comb, being locked to a resonance peak of the optical cavity 110.

Further, the optical frequency comb may be controlled to achieve a zero offset through self-referencing. In particular, the frequency tuned for locking to the optical cavity 110 is adjusted to offset. Accordingly, an f-2f interferometer 120 may detect the carrier-envelope offset of the source laser 100, and a circuit that feeds back a signal to offset the frequency tuned for locking the carrier-envelope offset to the optical cavity 110. This signal is directed to a pump laser diode (LD) that controls the source laser 100.

Additionally, the terahertz frequency generator 10 may actively remove any thermal noise generated from an optical fiber transmission line.

Through the optical frequency comb stabilization and the thermal noise compensation, the frequency v₁ of the n-th comb line becomes v₁=nfᵣ which is an integer multiple of the repetition rate fᵣ, and the frequency v₂ of the m-th comb line becomes v₂=mfᵣ which is an integer multiple of the repetition rate fᵣ. Through heterodyne optical coupling of both optical frequencies v₁=nfᵣ and v₂=mfᵣ, a terahertz frequency fₜ=(m−n)fᵣ may be generated. Here, by arbitrarily selecting comb lines that are heterodyne optically coupled, a desired terahertz frequency may be generated.

Referring to FIG. 2, the terahertz frequency generator 10 may include a stabilization module for stabilizing the source laser 100, and a heterodyne module 300 which extracts a pair of comb lines v₁ and v₂ from the optical frequency comb, and optically couples the pair of comb lines v₁ and v₂. The photomixer 200 may convert an optical signal generated by the heterodyne module 300 into the terahertz frequency, and emit the terahertz wave. The heterodyne module 300 may include a circuit for compensating for thermal noise in an optical fiber.

The stabilization module may include a first stabilization module that stabilizes the optical frequency comb to a separate frequency reference source, and a second stabilization module that stabilizes the optical frequency comb through self-referencing. The optical frequency comb is stabilized to the optical cavity 110 with a zero carrier-envelope offset by the stabilization module.

First, the first stabilization module that stabilizes the source laser 100 to the optical cavity 110 may include a comb line extraction unit 130, a control unit 140, and an acousto-optic modulator (AOM) 150.

The optical cavity 110 may, for example, be made of ultra-low expansion (ULE) glass, and may provide a resonance peak which is uniformly repeated in a free spectral range (FSR) of 3.14 GHz. Each resonance peak may provide a narrow bandwidth of 8 kHz jointly with a high finesse of 4×10⁵ under strict regulations on surrounding temperature, humidity, and vibration.

The comb line extraction unit 130 extracts one comb line v₃ in the optical frequency comb, which is locked to the optical cavity 110. The comb line extraction unit 130 may include, for example, an optical filter which filters out a comb line of a frequency designated in an adjacent spectrum, a distributed feedback laser diode (DFB LD), and an optic circulator. The optical filter may be configured by coupling a fiber Fabri-Perot (FFP) filter and a fiber Bragg grating (FBG) filter, for example. The filtered comb line may be injection-locked to the distributed feedback laser diode (DFB LD), and extracted, for power amplification. Here, a power amplification process through injection locking does not degrade original stability inherited from a source.

The control unit 140 performs a control to lock one comb line v3 to the resonance peak of the optical cavity 110. The control unit 140 may be configured to perform a Pound-Drever-Hall (PDH) control. For example, the control unit 140 modulates a phase of the extracted comb line by using an electro-optic modulator (EOM), detects an error signal of the resonance peak and the comb line of the optical cavity 110 by using a photo detector (PD), and then output a driving frequency f_{AOM} of the AOM 150 for inhibiting the error signal.

The AOM 150 shifts an entire structure of the optical frequency comb according to the driving frequency f_{AOM}, and as a result, the comb line v₃ is locked to the resonance peak of the optical cavity 110 by reducing an error from the optical cavity 110. That is, the entire structure of the optical frequency comb is turned according to the frequency domain through the AOM 150, and the comb line v₃ extracted from the optical frequency comb is made to be accurately locked to the resonance peak of the optical cavity 110 through the Pound-Drever-Hall (PDH) control.

On the other hand, a control frequency used to shift the optical frequency comb for locking to the optical cavity 110 affects the overall offset of the optical frequency comb. Specifically, the total offset of the optical frequency comb is a sum of the carrier envelope offset fₒ and the driving frequency f_{AOM} of the AOM 150. The carrier envelope offset fₒ of the optical frequency comb is controlled by a pump laser diode (LD) 180 connected to the source laser 100. Consequently, the pump LD 180 adjusts the carrier envelope offset fₒ to counterbalance the driving frequency f_{AOM} of the AOM 150 (that is, fₒ=−f_{AOM}), allowing the second stabilization module to set the total offset of the optical frequency comb to zero.

For example, the f-2f interferometer 120 and the optical detector 160 detect the carrier envelope offset fₒ in the output of the source laser 100. The feedback circuit then generates a feedback signal (an error signal from −f_{AOM}) for the detected offset fₒ, and transmits the generated feedback signal to the pump LD 180. Here, the feedback circuit may consist of a phase-locked loop (PLL) 170 and a voltage-controlled oscillator (VCO) 171 set to −f_{AOM}, and is configured to generate the feedback signal (error signal) for the detected offset fₒ, and transmit the generated feedback signal to the pump LD 180. When the pump LD 180 receives the feedback signal, the source laser may output an optical frequency comb with the carrier-envelope offset fₒ equal to −f_{AOM}. As a result, the optical frequency comb stabilized to the optical cavity 110 may be incident on the heterodyne module 300 with a zero offset (fₒ+f_{AOM}=0), allowing the heterodyne module 300 to extract the comb line from the stabilized optical frequency comb.

Referring to FIG. 3, the heterodyne module 300 may include a pair of comb line extraction units 310 and 311 extracting a pair of comb lines v₁ and v₂ from the stabilized optical frequency comb. These two extracted comb lines are then optically coupled to generate an optical terahertz signal.

Each of the comb line extraction units 310 and 311 may consist of the optical filter which filters out a comb line of a designated frequency from an adjacent spectrum, the distributed feedback laser diode (DFB LD), and the optical circulator like the comb line extraction unit 130 described in FIG. 2.

The optical filter may be configured by coupling a fiber Fabri-Perot (FFP) filter and a fiber Bragg grating (FBG) filter, for example. The filtered comb line may be injection-locked to the distributed feedback laser diode (DFB LD), and extracted, for power amplification. Here, the DFB LD of at least one of the comb line extraction units 310 and 311 may be configured to successively shift in an operating window of the injection locking to scan the comb line in the frequency domain. Through this, a terahertz frequency determined by an optical difference of a pair of comb lines may be arbitrarily tuned.

A first comb line (v₁=nfᵣ) output by a first comb line extraction unit 310 and a second comb line (v₂=mfᵣ) output by a second comb line extraction unit 311 are transferred through an optical fiber transmission line. The optical fiber transmission line may go through a polarization controller (PC).

A pair of comb lines are optically coupled by an optical coupler before being input into the photomixer 200, generating an optical signal (optical terahertz signal) corresponding to the optical difference |v₁−v₂| between the two comb lines. The optical signal output from the heterodyne module 300 may be then converted into the terahertz wave by the photomixer 200.

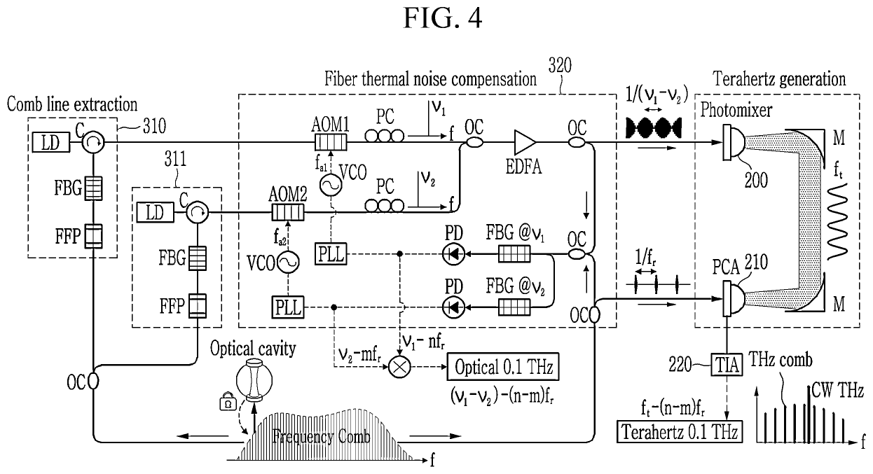

Meanwhile, the optical fiber transmission line of each comb line requires a significant length (at least 5 m) to accommodate all functional components (FFP filter, FBG filter, LD, and AOM) from the source laser 100 to the photomixer 200. A long optical fiber transmission line introduces thermal noise which is random and not interrelated, causing fractional frequency (Δf/f) instability of 10⁻¹⁶. While this instability from the thermal noise may be negligible in an optical frequency domain, in a terahertz region, the thermal noise Δf remains similar, but the denominator frequency f undergoes a three order down-conversion, amplifying its impact. Therefore, the thermal noise in the optical fiber transmission line should be actively corrected through the phase locked loop (PLL) control. Details of thermal noise compensation circuit for this are provided in FIG. 4.

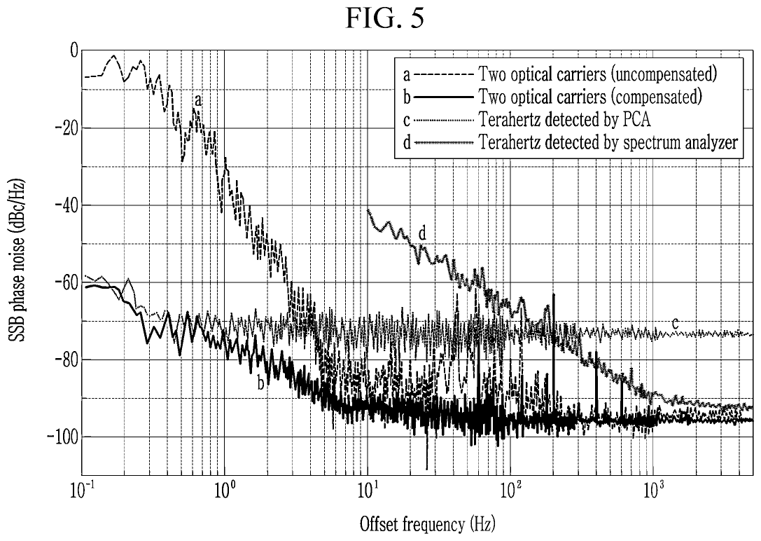

FIG. 4 is a configuration diagram of a terahertz frequency generator including a thermal noise compensation circuit and a terahertz phase noise measurement according to an exemplary embodiment, and FIG. 5 is a graph showing a phase noise performance according to an exemplary embodiment.

Referring to FIG. 4, a frequency stability of a terahertz wave generated by photo-mixing is affected by the thermal noise of the optical fiber transmission line as well as the stability of the optical frequency comb. Accordingly, the terahertz frequency generator 10 may be configured to extract a pair of comb lines v₁ and v₂, for photo-mixing through the comb line extraction units 310 and 311, and compensate for the thermal noise in the optical fiber transmission line connected up to the photomixer 200 through the thermal noise compensation circuit 320.

The thermal noise compensation circuit 320 may be configured to actively compensate for the thermal noise in the optical fiber transmission line by modulating the comb lines extracted by the comb line extraction units 310 and 311 based on an optical signal detected at an end of the optical fiber transmission line (i.e., an inlet of the photomixer 200) through a feedback circuit (e.g., phase-locked loop (PLL) circuit). The comb lines extracted by the comb line extraction units 310 and 311 may be upshift-modulated (fa1 and fa2) through AOM1 and AOM2 which follow the phase-locked loop (PLL) control, respectively. Differences (v₁−nfᵣ and v₂−mfᵣ) between the respective comb lines v₁ and v₂ modulated by AOM1 and AOM2, and a source comb are fed back to AOM1 and AOM2 to actively compensate for the thermal noise of the heterodyne module 300.

In this case, an optical terahertz signal may generate an intermediate beatnote (e.g., 100 kHz), which corresponds to a difference between fₐ₁ (e.g., 39.95 MHZ) and fₐ₂ (e.g., 40.05 MHz) through beating with an original difference of the source comb. This RF beatnote is sampled through an FFT analyzer, allowing for the evaluation of the phase noise spectrum of an optically transmitted terahertz signal.

Next, terahertz phase noise measurement is described.

The photomixer 200 may output a terahertz wave corresponding to an optical difference |v₁−v₂| between a pair of comb lines, and detect the terahertz wave through a photoconductive antenna (PCA) 210. Photocurrent generated by the photoconductive antenna 210 may be amplified to a voltage signal through a transimpedance amplifier (TIA) 220.

Further, pulse train from the source laser 100 partially enters the photoconductive antenna 210, generating a terahertz comb. Gate pulse train incident on the photoconductive antenna 210, which generating the terahertz comb, may be adjusted to achieve an optical output of 30 mW with a pulse duration, e.g., 130 fs through distribution compensation of the optical fiber transmission line.

A down-converted source comb as a terahertz frequency criterion is made to interfere with the terahertz wave output by the photomixer 200, and a lowest RF beat acquired by interference is monitored through the transimpedance amplifier (TIA) 220. That is, an actual terahertz wave output by the photomixer 200 may be detected in the form of the beatnote in interference with the terahertz comb down-converted from a source optical frequency comb. The detected beatnote may be shown as the phase noise spectrum for the actual terahertz wave through the FFT analyzer.

Referring to FIG. 5, phase noise of the optical terahertz signal by a difference |v₁−v₂| between two comb lines may be measured in an optical region at an inlet of the photomixer 200.

First, in the optically transferred terahertz signal, when thermal noise in an optical cable is not compensated, a phase noise level of up to −32.5 dBc/Hz may be shown in a 1 Hz offset as in Graph a.

On the other hand, it may be confirmed that when the thermal noise in the optical fiber transmission line is compensated through the thermal noise compensation circuit 320 of the present disclosure, the phase noise is reduced to −73.5 dBc/Hz at 1 Hz and further reduced to −95.4 dBc/Hz at 10 Hz as in Graph b. This indicates that the thermal noise in the optical fiber may be improved by approximately 30 dB through the phase-locked loop control of the thermal noise compensation circuit 320, with additional improvements possible by altering the environmental condition.

Graph c shows phase noise measured through the photoconductive antenna (PCA). The terahertz wave detected by the photoconductive antenna (PCA) may have a phase noise level of −73 dBc/Hz compared to Graph b in which the terahertz wave is optically transferred.

Meanwhile, the terahertz wave output by the photomixer 200 may be directly measured using a commercial terahertz spectrum analyzer. Phase noise measured by the spectrum analyzer in Graph d may be measured to be larger than the phase noise measured through the photoconductive antenna (PCA) in Graph c.

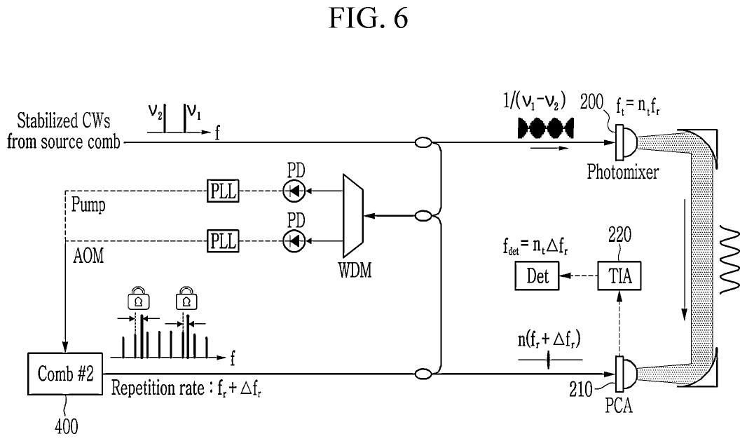

FIG. 6 is a configuration diagram for absolute measurement of a terahertz frequency according to an exemplary embodiment.

Referring to FIG. 6, an additional laser 400 may be used to directly determine an absolute frequency of the terahertz wave instead of determining the frequency of the terahertz wave as the difference |v₁−v₂| between two comb lines. Comb #2 output by the additional laser 400 may be designated as a reference comb input into the photoconductive antenna (PCA) 210, allowing it to be differentiated from the source comb.

The additional laser 400 may be stabilized by integrating two phase locked loops (PLLs) for two comb lines v₁ and v₂ selected for heterodyne optical coupling, and may have a repetition rate different from a repetition rate fᵣ of the source laser 100 by Δfᵣ. For the phase-locked loop (PLL) control for synchronization between the source laser 100 and the additional laser 400, beatnotes f_{b1} and f_{b2} between two comb lines v₁ and v₂ may be individually detected through a photodetector PD. The beatnote may go through a frequency processing, and then may be mixed with a value previously allocated by a local oscillator. Subsequently, an error signal may be individually PLL-corrected through a pump current port and a PID servo controller of the additional laser 400.

A comb of the additional laser 400 in which the repetition rate is fᵣ+Δfᵣ is incident on the photoconductive antenna (PCA) 210 to be made to interfere with the terahertz wave, and a lowest RF beat f_{det} which is acquired by interference is monitored through the trans-impedance amplifier (TIA) 220.

Since the terahertz frequency fₜ is generated by heterodyne mixture of two comb lines, the terahertz frequency fₜ may be calculated by a product (fₜ=n*fᵣ) of an absolute mode order nₜ (=n₁−n₂) of the terahertz frequency and the repetition rate fᵣ of the source laser 100. Here, the absolute mode order nₜ of the terahertz frequency is determined as nₜ=f_{det}/Δ fᵣ, and since both the RF beat f_{det} and the repetition rate difference Δfᵣ are known information, the terahertz frequency may be calculated through this.

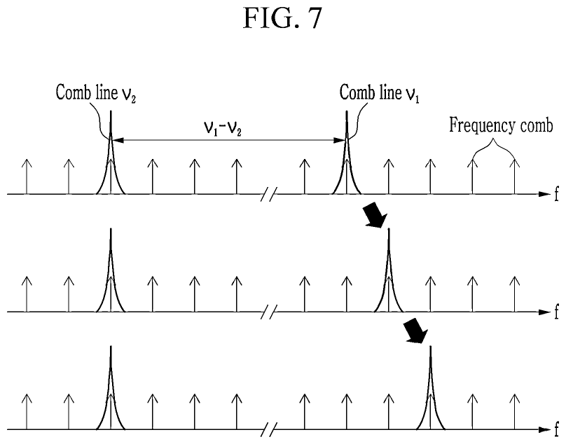

FIG. 7 is a diagram for describing continuous tuning of the terahertz frequency according to an exemplary embodiment.

Referring to FIG. 7, the terahertz frequency generator 10 may generate the terahertz frequency in a continuous scanning mode. For example, a DFB LD which performs injection locking of v₁ in a first comb line extraction unit 310 is placed in a programmable current control sequence and successively shifts in an operating window of the injection locking to extract all comb lines at a next frequency.

In the case of the existing technology that tunes the terahertz frequency by changing the repetition rate of the optical frequency comb, the source laser does not operate intrinsically in a stabilization state. However, in the terahertz frequency generator 10 of the present disclosure, one comb line v₁ may shift to a next comb line without releasing the stabilization of the source laser, and at the same time, the other comb line v₂ may be maintained in a fixed state.

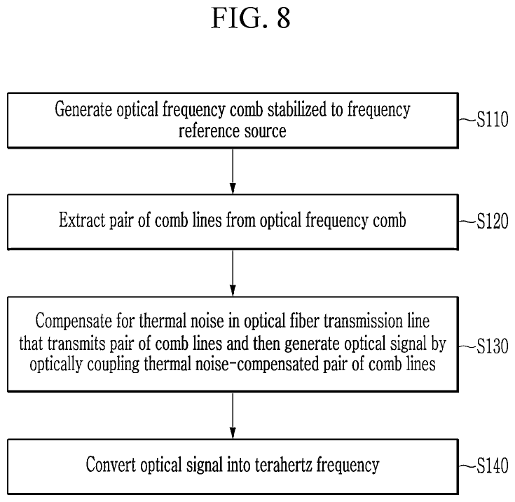

FIG. 8 is a flowchart of a terahertz frequency generation method according to an exemplary embodiment.

Referring to FIG. 8, a terahertz frequency generator 10 generates an optical frequency comb stabilized to a frequency reference source (S110). The frequency reference source may be, for example, an optical cavity made of ultra-low expansion (ULE) glass. The optical frequency comb may be controlled to a zero offset through self-referencing.

The terahertz frequency generator 10 extracts a pair of comb lines from the optical frequency comb (S120). A pair of comb lines may be selected so that an optical difference thereof becomes a desired terahertz frequency. Further, a comb line of a desired frequency mode may be extracted while scanning a frequency domain by controlling injection locking of a laser diode that extracts the comb line. Through this, the terahertz frequency generator 10 may generate a wide range of terahertz frequencies. The terahertz frequency generator 10 compensates for thermal noise in an optical fiber transmission line that transmits a pair of comb lines using a thermal noise compensation circuit 320, and then generates an optical signal by optically coupling the thermal noise-compensated pair of comb lines (S130). The optical signal may be an optical terahertz signal corresponding to an optical difference |v₁−v₂| between the pair of comb lines.

The terahertz frequency generator 10 converts the optical signal into the terahertz frequency using a photomixer 200 (S140).

As described up to now, the terahertz frequency generator 10 may generate the terahertz frequency by photo-mixing a pair of comb lines extracted from the stabilized optical frequency comb. The terahertz frequency generator 10 successively shifts at least one comb line of the pair of comb lines without releasing the stabilization of the optical frequency comb to generate a wide range of terahertz frequency.

The terahertz frequency generator 10 may provide a phase noise performance at a very low level of −70 dBc/Hz at a 1 Hz offset, and generate a terahertz frequency having high stability and accuracy. Therefore, a signal to noise ratio of a terahertz radar, a decomposition ability of terahertz molecular spectroscopy, and a transmission capacity of wireless communication can be dramatically improved.

The exemplary embodiments of the present disclosure described above are not configured only through the apparatus and the method and can be configured through a program which realizes a function corresponding to a configuration of the exemplary embodiments of the present disclosure or a recording medium having the program recorded therein.

While the exemplary embodiments of the present invention have been described above in detail, it is to be understood that the scope of the present invention is not limited to the disclosed exemplary embodiments, but, on the contrary, is intended to cover various modifications and equivalent arrangements included within the spirit and scope of the appended claims.

What is claimed is:

1. A terahertz frequency generator comprising:
a source laser configured to output an optical frequency comb;
a first stabilization module configured to stabilize the optical frequency comb to a frequency reference source;
a heterodyne module configured to extract a pair of comb lines from the stabilized optical frequency comb, with a frequency difference corresponding to a terahertz frequency, and optically couple the pair of comb lines; and
a photomixer configured to convert an optical signal generated by the heterodyne module into the terahertz frequency.

2. The terahertz frequency generator of claim 1, wherein the frequency reference source includes an optical cavity made of ultra-low expansion glass.

3. The terahertz frequency generator of claim 2, wherein the first stabilization module comprises:
a comb line extraction unit configured to extract a specific comb line from the optical frequency comb;
a control unit configured to generate a control frequency for locking the specific comb line to a resonance peak of the optical cavity; and
an acousto-optic modulator configured to shift the optical frequency comb according to the control frequency.

4. The terahertz frequency generator of claim 3, further comprising:
a second stabilization module configured to stabilize the optical frequency comb through self-referencing,
wherein the second stabilization module comprises:
an interferometer configured to detect a carrier-envelope offset in an output of the source laser;
a feedback circuit configured to generate a feedback signal to counterbalance the control frequency by the carrier-envelope offset; and
a pump laser diode configured to adjust the carrier-envelope offset output by the source laser based on the feedback signal.

5. The terahertz frequency generator of claim 1, wherein the heterodyne module comprises:
a pair of comb line extraction units configured to extract the pair of comb lines from the stabilized optical frequency comb; and
a thermal noise compensation circuit configured to actively compensate for thermal noise in an optical fiber transmission line by modulating each comb line output from each of the pair of comb line extraction units based on the optical signal detected at an inlet of the photomixer.

6. The terahertz frequency generator of claim 5, wherein the thermal noise compensation circuit comprises:
a pair of acousto-optic modulators configured to modulate the comb lines extracted by the pair of comb line extraction units; and
a circuit configured to feedback a difference between each comb line modulated by each of the pair of acousto-optic modulators and the optical frequency comb to the corresponding acousto-optic modulator.

7. The terahertz frequency generator of claim 5, wherein each of the pair of comb line extraction units comprises:
an optical filter configured to filter out a designated comb line from the optical frequency comb; and
a laser diode configured to extract a comb line of a frequency mode designated through injection locking for the comb line filtered out by the optical filter.

8. The terahertz frequency generator of claim 6, wherein the laser diode of at least one of the pair of comb line extraction units is configured to successively shift in an operating window of the injection locking to scan the extracted comb line.

9. A terahertz frequency generator comprising:
a source laser configured to output an optical frequency comb;
a first stabilization module configured to stabilize the optical frequency comb to a frequency reference source;
a second stabilization module configured to stabilize the optical frequency comb through self-referencing; and
a heterodyne module configured to extract a pair of comb lines from the stabilized optical frequency comb, with a frequency difference corresponding to a terahertz frequency, compensate for thermal noise in an optical fiber transmission line of the pair of comb lines, and then optically couple the thermal noise-compensated pair of comb lines.

10. The terahertz frequency generator of claim 9, wherein the frequency reference source includes an optical cavity made of ultra-low expansion glass.

11. The terahertz frequency generator of claim 10, wherein the first stabilize module comprises:
a comb line extraction unit configured to extract a specific comb line from the optical frequency comb;
a control unit configured to generate a control frequency for locking the specific comb line to a resonance peak of the optical cavity; and
an acousto-optic modulator configured to shift the optical frequency comb according to the control frequency.

12. The terahertz frequency generator of claim 11, wherein the second stabilization module comprises:
an interferometer configured to detect a carrier-envelope offset in an output of the source laser;
a feedback circuit configured to generate a feedback signal to counterbalance the control frequency by the carrier-envelope offset; and
a pump laser diode configured to adjust the carrier-envelope offset output by the source laser based on the feedback signal.

13. The terahertz frequency generator of claim 9, wherein the heterodyne module comprises:
a pair of comb line extraction units configured to extract the pair of comb lines from the stabilized optical frequency comb; and
a thermal noise compensation circuit configured to actively compensate for the thermal noise in the optical fiber transmission line by modulating each comb line output by each of the pair of comb line extraction units based on the optical signal detected at an end of the optical fiber transmission line.

14. The terahertz frequency generator of claim 13, wherein the thermal noise compensation circuit comprises:
a pair of acousto-optic modulators configured to modulate the comb lines extracted by the pair of comb line extraction units; and
a circuit configured to feedback a difference between each comb line modulated by each of the pair of acousto-optic modulators and the optical frequency comb to the corresponding acousto-optic modulator.

15. The terahertz frequency generator of claim 14, wherein each of the pair of comb line extraction units comprises:
an optical filter configured to filter out a designated comb line from the optical frequency comb; and
a laser diode configured to extract a comb line of a frequency mode designated through injection locking for the comb line filtered out by the optical filter.

16. The terahertz frequency generator of claim 15, wherein the laser diode of at least one of the pair of comb line extraction units is configured to successively shift in an operating window of the injection locking to scan the extracted comb line.

17. The terahertz frequency generator of claim 9, further comprising:
a photomixer configured to convert an optical signal generated by the heterodyne module into the terahertz frequency.

18. An operating method of a terahertz frequency generator, comprising:
generating an optical frequency comb stabilized to a frequency reference source;
extracting a pair of comb lines from the stabilized optical frequency comb, with a frequency difference corresponding to a terahertz frequency;
compensating for thermal noise in an optical fiber transmission line that transmits the pair of comb lines, using a thermal noise compensation circuit;
generating an optical signal by optically coupling the thermal noise-compensated pair of comb lines; and
converting the optical signal into the terahertz frequency using a photomixer.

19. The operating method of claim 18, further comprising:
stabilizing the optical frequency comb through self-referencing.

20. The operating method of claim 18, wherein the extracting the pair of comb lines comprises extracting a comb line of a specific frequency mode while scanning a frequency domain by controlling injection locking of a laser diode, which extracts one comb line of the pair of comb lines.
